(19) United States
(12) Patent Application Publication
(10) Pub. No.: US 2024/0319327 A1
(43) Pub. Date: Sep. 26, 2024

(54) Radar Cover for a Vehicle Radar System

(71) Applicant: Bendix Commercial Vehicle Systems LLC, Avon, OH (US)

(72) Inventors: Douglas Wright, North Royalton, OH (US); Moises Armando Cruz Morales, Villa Santa Lucia (MX); Anthony J. Cydzik, LaGrange, OH (US); Robert G. Patterson, Burnaby (CA)

(21) Appl. No.: 18/187,202

(22) Filed: Mar. 21, 2023

(51) Int. Cl. G01S 7/02; G01S 13/931

(52) U.S. Cl. CPC G01S 7/027; G01S 13/931; G01S 2013/9327

(57) ABSTRACT

A vehicle radar apparatus comprises a radar cover including a wall having a longitudinal wall portion and at least one lateral wall portion curving away from the longitudinal wall portion and positioned relative to the longitudinal wall portion such that both wall portions have substantially uniform wall thickness.

### BACKGROUND

The present application relates to vehicle radar systems, and is particularly directed to a radar cover for a vehicle radar system, such as a radar system mounted on a heavy vehicle.

A typical radar system of a heavy vehicle, such as a truck, includes a radar sensor that is fastened to a bracket using screws. The bracket in turn is fastened to a bumper or a cross member of the truck using suitable fasteners. In some trucks, a radar cover is also fastened to the bracket to protect the radar sensor from road debris. While a radar cover protects the radar sensor from road debris, the radar cover impedes radar waves emitted from the radar sensor and reflected radar waves received by the radar sensor. Accordingly, those skilled in the art continue with research and development efforts in the field of vehicle radar systems including radar sensors and radar covers.

### SUMMARY

In accordance with one example embodiment, a vehicle radar apparatus comprises a radar cover including a wall having a longitudinal wall portion and at least one lateral wall portion curving away from the longitudinal wall portion and positioned relative to the longitudinal wall portion such that both wall portions have substantially uniform wall thickness.

In accordance with another example embodiment, a vehicle radar apparatus comprises a bracket fastenable to a vehicle part, and a radar sensor assembly fastened to the bracket and including a radar sensor for emitting radar waves and receiving reflected radar waves. The vehicle radar apparatus also comprises a radar cover secured to the radar sensor assembly and for protecting the radar sensor from road debris during vehicle operation. The radar cover has a wall thickness that is substantially uniform across a field of view of the radar sensor.

In accordance with yet another example embodiment, a vehicle radar apparatus comprises a radar sensor assembly including a radar sensor for emitting radar waves and receiving reflected radar waves. The vehicle radar apparatus also comprises a radar cover secured to the radar sensor assembly and for protecting the radar sensor from road debris during vehicle operation, wherein the radar cover includes a plurality of retention tabs for enabling the radar cover to be secured to the radar sensor assembly without use of fasteners.

### BRIEF DESCRIPTION OF THE DRAWINGS

FIG. 1 is a perspective view of a vehicle radar apparatus embodying a radar cover constructed in accordance with an embodiment.

FIG. 2 is a perspective view of the radar cover of FIG. 1, looking approximately in the direction of arrow 2 in FIG. 1.

FIG. 2A is a perspective view of the radar cover of FIG. 2, looking approximately in the direction of arrow 2A in FIG. 2.

FIG. 3 is a perspective view of a vehicle radar apparatus embodying a radar cover constructed in accordance with another embodiment.

FIG. 3A is a perspective view of the radar cover of FIG. 3, looking approximately in the direction of arrow 3A in FIG. 3.

FIG. 3B is a perspective view of the radar cover of FIG. 3A, looking approximately in the direction of arrow 3B in FIG. 3A.

FIG. 3C is a top view, taken approximately along line 3C-3C in FIG. 3A, showing contour of a wall of the radar cover.

FIG. 3D is a schematic diagram of a portion of FIG. 3C, designated with oval 3D, showing contour details of the wall of the radar cover.

### DETAILED DESCRIPTION

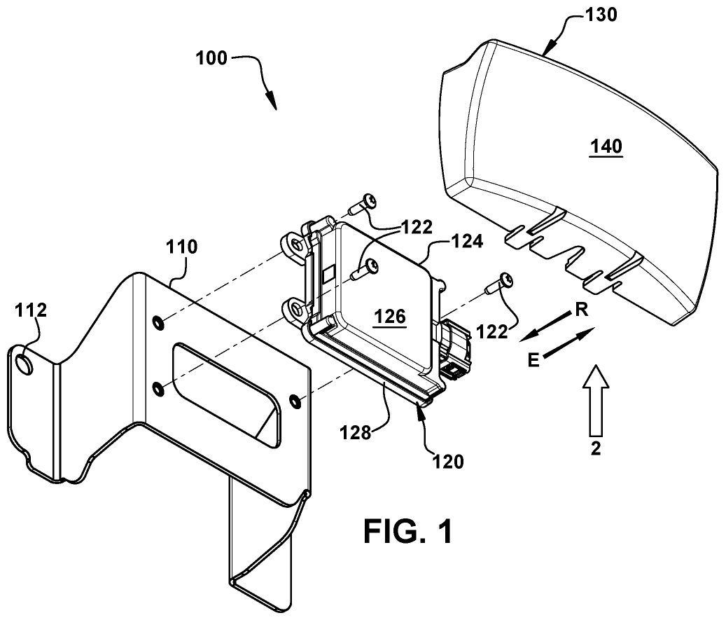

Referring to FIG. 1, a perspective view is illustrated of a vehicle radar apparatus 100 embodying a radar cover 130 constructed in accordance with an embodiment. A radar mounting bracket 110 has a number of holes 112 (only one hole shown in FIG. 1) through which suitable hardware (not shown) is used to fasten the bracket 110 to a vehicle part (also not shown) such as a bumper or a cross member of the vehicle. A radar sensor assembly 120 is fastened to the bracket 110 using suitable hardware 122 such as screws or bolts. The radar sensor assembly 120 includes a radar sensor 124 for emitting radar waves (i.e., radar signals) and receiving reflected radar waves.

The radar sensor 124 has a front surface 126 and a back surface 128, and may comprise any type of radar sensor, such as an mmWave radar sensor having a designed (i.e., an intended) carrier frequency of radar wave transmission (e.g., 76.5 Ghz). As shown in FIG. 1, the radar sensor 124 emits radar waves in a direction designated by arrow line “E” away from the vehicle. The emission wave pattern typically fans out vertically, and much more so laterally. The radar sensor 124 receives reflected radar waves in a direction designated by arrow line “R” towards the vehicle. The reflection wave pattern typically converges vertically, and much more so laterally.

The radar cover 130 has a wall 140, and is secured to the radar sensor assembly 120. The radar cover 130 covers and protects the radar sensor 124 from road debris during vehicle operation. The radar cover 130 may comprise material that is injection molded. For example, the radar cover 130 may comprise Celanex® 2104UV-PBT, commercially available from Celanese Corporation, located in Irving Texas. Other plastic materials are possible.

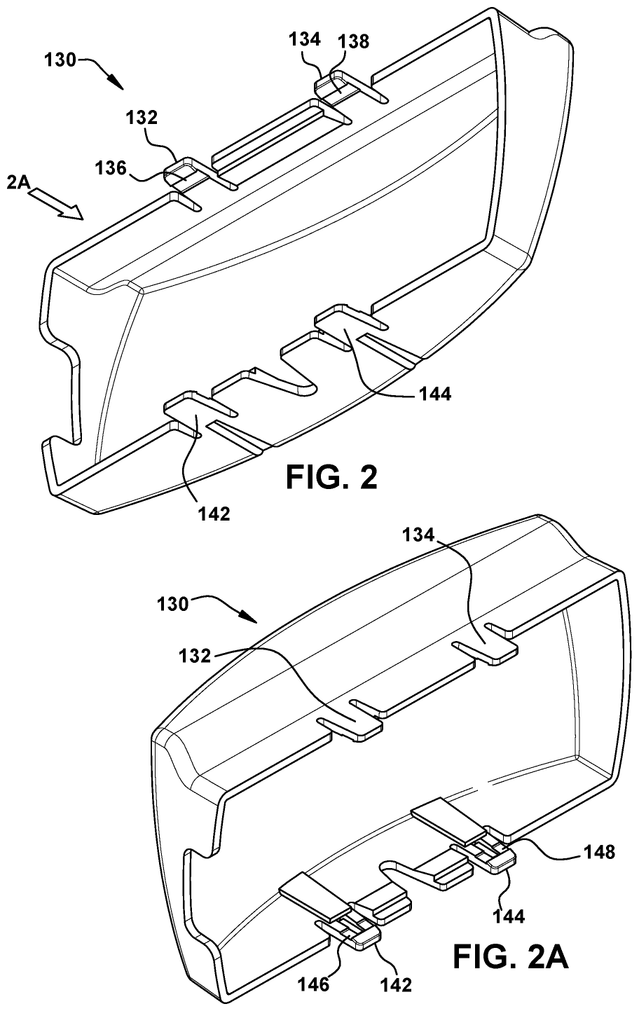

Referring to FIG. 2, a perspective view is illustrated of the radar cover 130 of FIG. 1, looking approximately in the direction of arrow 2 in FIG. 1. FIG. 2 shows details of upper retention tabs 132, 134 of the radar cover 130. The upper retention tabs 132, 134 have corresponding slotted surfaces 136, 138 that engage a top edge of the back surface 128 of the radar sensor 124.

Referring to FIG. 2A, a perspective view is illustrated of the radar cover of FIG. 2, looking approximately in the direction of arrow 2A in FIG. 2. FIG. 2A shows details of lower retention tabs 142, 144 of the radar cover 130. The lower retention tabs 142, 144 have corresponding slotted surfaces 146, 148 that engage a bottom edge of the back surface 128 (FIG. 1) of the radar sensor 124.

Each of the plurality of retention tabs 132, 134, 142, 144 has resilience (i.e., inherent springiness), and clamps onto only components of the radar sensor assembly 120 to secure the radar cover 130 to the radar sensor assembly 120. The retention tabs 132, 134, 142, 144 cooperate together to enable the radar cover 130 to be secured to the radar sensor assembly 120 without use of fasteners.

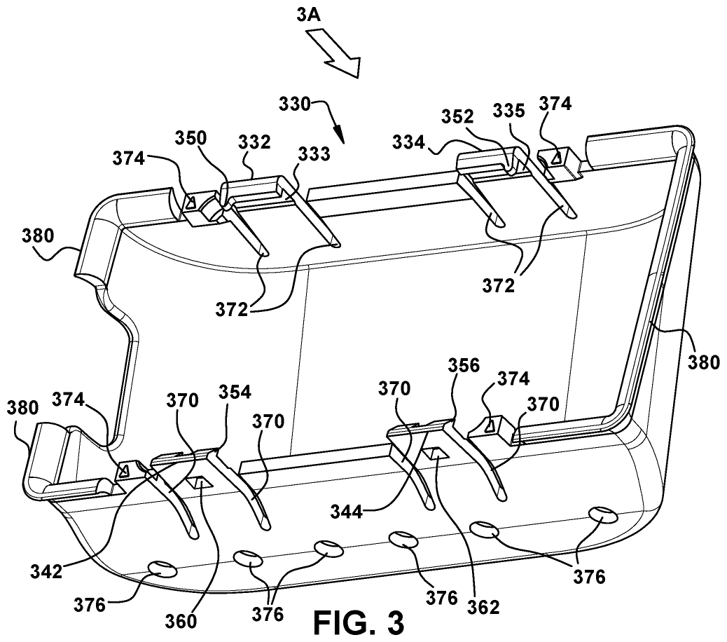

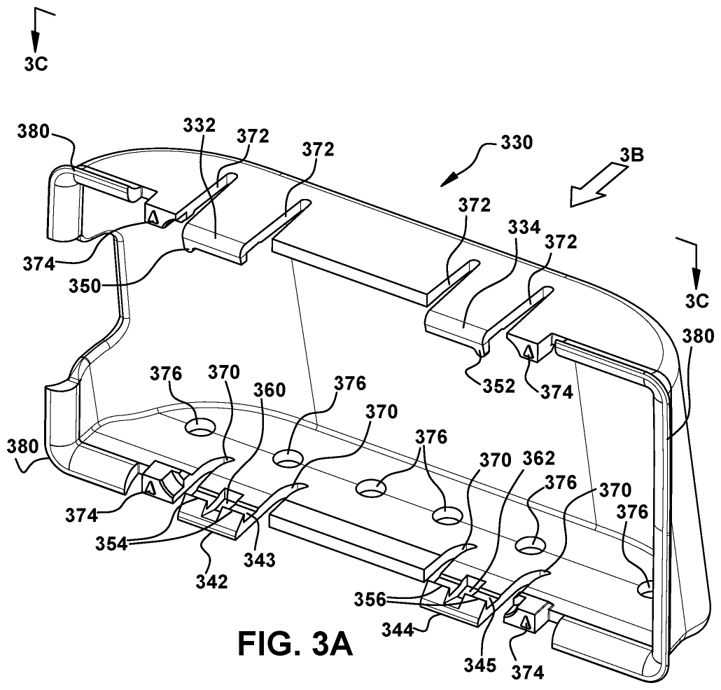

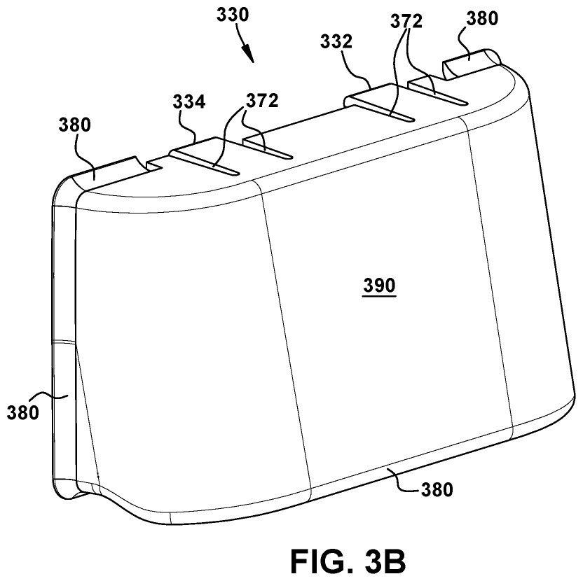

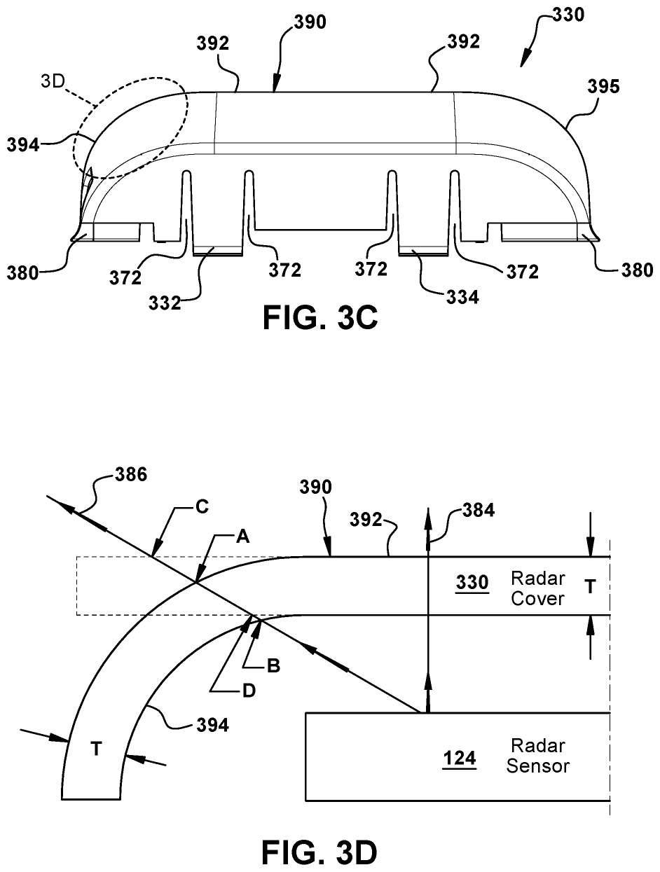

Referring to FIG. 3, a perspective view of a vehicle radar apparatus embodying a radar cover 330 constructed in accordance with another embodiment is illustrated. The design of the radar cover 330 shown in FIG. 3 is different from the design of the radar cover 130 shown in FIGS. 2, 2A, and 2B. The radar cover 330 of FIG. 3 can be used in place of the radar cover 130 that is shown in FIG. 1. For purpose of explanation, the radar cover 330 of FIG. 3 will be described using the radar mounting bracket 110 and the radar sensor assembly 120 including the radar sensor 124 shown in FIG. 1.

FIG. 3 shows upper retention tabs 332, 334 of the radar cover 330 and lower retention tabs 342, 344 of the radar cover 330. The upper retention tab 332 has a slotted surface 333 that engages the top edge of the back surface 128 of the radar sensor 124. The upper retention tab 332 also has an extended (i.e., projected) surface portion 350 that hooks onto the top edge of the back surface 128 of the radar sensor 124. Similarly, the upper retention tab 334 has a slotted surface 335 that engages the top edge of the back surface 128 of the radar sensor 124. The upper retention tab 334 also has an extended surface portion 352 that hooks onto the top edge of the back surface 128 of the radar sensor 124.

Referring to FIG. 3A, a perspective view of the radar cover 330 of FIG. 3, looking approximately in the direction of arrow 3A in FIG. 3, is illustrated. As best shown in FIG. 3A, the lower retention tab 342 has a slotted surface 343 that engages the bottom edge of the back surface 128 of the radar sensor 124. The lower retention tab 342 also has an extended surface portion 354 that hooks onto the bottom edge of the back surface 128 of the radar sensor 124. Similarly, the lower retention tab 344 has a slotted surface 345 that engages the bottom edge of the back surface 128 of the radar sensor 124. The lower retention tab 344 also has an extended surface portion 356 that hooks onto the bottom edge of the back surface 128 of the radar sensor 124.

Each of the plurality of retention tabs 332, 334, 342, 344 shown in FIG. 3 has resilience, and not only clamps but also hooks onto only components of the radar sensor assembly 120 to secure the radar cover 330 to the radar sensor assembly 120. The retention tabs 332, 334, 342, 344 cooperate together to enable the radar cover 330 to be secured to the radar sensor assembly 120 without use of fasteners.

The lower retention tab 342 has an elongated slot 360 (see also FIG. 3) through which a screwdriver (not shown) can be inserted and used as a lever to unhook and thereby remove the extended surface portion 354 from the radar sensor 124. Similarly, the lower retention tab 344 has an elongated slot 362 through which a screwdriver can be inserted and used as a lever to unhook and thereby remove the extended surface portion 356 from radar sensor 124.

As shown in FIGS. 3 and 3A, the radar cover 330 has a plurality of slots 370 that assist in creating a spring feature (beam function) for the lower retention tabs 342, 344. Due to this feature, the radar cover 330 is able to deflect during installation without permanently distorting the shape of the radar cover 330. Similarly, the radar cover 330 has a plurality of slots 372 that assist in creating the spring feature for the upper retention tabs 332, 334. Radar cover 330 also includes at least two longitudinal locating features 374 that assist in aligning the radar sensor assembly 120 within the radar cover 330 during installation.

The radar cover 330 may also include a plurality of drainage holes 376. Water and debris can freely exit the radar cover 330 as the drainage holes 376 are located at the bottom of a properly installed radar cover 330. The particular arrangement of six drainage holes is such that the rigidity of the radar cover 330 is not impacted.

Referring to FIG. 3B, a perspective view of the radar cover 330 of FIG. 3A, looking approximately in the direction of arrow 3B in FIG. 3A, is illustrated. The radar cover 330 includes a wall 390 having a thickness that is substantially uniform across a field of view of the radar sensor 124. The substantially uniform wall thickness of the wall 390 of the radar cover 330 supports optimized transmissivity of radar waves away from and reflected radar waves towards the radar sensor 124.

As best shown in FIG. 3B, the radar cover 330 may also include a spoiler 380 (extended edge, lip) extending from edge of the radar cover 330 that is nearest the radar sensor assembly 120 after installation. The spoiler 380 deflects and diverts airflow around the radar cover 330 and away from the back side. The purpose of deflected airflow is twofold. When airflow is deflected, dirt-laden air has less of a tendency to swirl behind the radar cover 330 and deposit on surfaces of the radar sensor assembly 120 and the radar cover 330. Deflected airflow also helps to reduce dirt buildup. Dirt buildup may lead to attenuated signal return and degraded radar functionality. In addition, breaking up the airflow moving past the radar cover 330 lowers the probability of airflow-induced resonances in the radar cover 330. Resonance of the radar cover 330 could degrade the functionality of the radar by attenuating the return signal.

Referring to FIG. 3C, a top view, taken approximately along line 3C-3C in FIG. 3A, shows contour of the wall 390 of the radar cover 330. The wall 390 has a wall thickness that is substantially uniform across a field of view of the radar sensor 124. The wall 390 includes a longitudinal wall portion 392 and a first lateral wall portion 394 that bends (i.e., curves) away from one end of the longitudinal wall portion 392. The longitudinal wall portion 392 and the curved lateral wall portion 394 are positioned relative to each other such that both wall portions 392, 394 have substantially uniform wall thickness.

Similarly, a second lateral wall portion 395 curves away from an opposite end of the longitudinal wall portion 392. The second lateral wall portion 395 and longitudinal wall portion 392 are also positioned relative to each other such that both wall portions 392, 395 have substantially uniform wall thickness. The second lateral wall portion 395 is a mirror image of the first lateral wall portion 394. For purpose of explanation, only the first lateral wall portion 394 will be described in detail herein.

Referring to FIG. 3D, a schematic diagram of a portion of FIG. 3C, designated oval 3D, shows contour details of the wall 390 of the radar cover 330. As shown in FIG. 3D, the wall portions 392, 394 of the radar cover 330 have a substantially uniform thickness T. Arrow line 384 represents an example path that a radar wave emitted from the radar sensor 124 follows when the emitted radar wave passes through the longitudinal wall portion 392. Arrow line 386 represents an example path that a radar wave emitted from the radar sensor 124 follows when the emitted radar wave passes through the curved lateral wall portion 394. The radar waves on line 386 passing through the curved lateral wall portion 394 are typically at extreme edges of a radar cone wave pattern from the radar sensor 124.

The positioning of the wall portions 392, 394 relative to each other and to the radar sensor 124, and the bending away of the first lateral wall portion 394 from the longitudinal wall portion 392 with the substantially uniform wall thickness T, together support optimized transmissivity of radar waves through the wall 390 of the radar cover 330.

For example, as shown in FIG. 3D, the radar wave from the radar sensor 124 emitted along the path of arrow line 386 travels a distance (shown as between points A and B) that is shorter than a distance (shown as between points C and D) that the radar wave would have had to travel if the longitudinal wall portion 392 continued extending straight (as shown by the dashed lines in FIG. 3D) instead of curving towards the first lateral wall portion 394 (as shown by the solid lines in FIG. 3D). The shorter distance between points A and B is preferable to the longer distance between points C and D, resulting in improved transmission of radar waves through the wall 390 of the radar cover 330. Thus, the thickness of the wall 390 and the shape of the wall 390, as defined by the relative positioning of the wall portions 392, 394 and the curvature between the wall portions 392, 394, together promote unimpeded transmission (and reception) of radar waves through the wall 390 of the radar cover 330.

In an example implementation of the radar cover 330 such as shown in FIG. 3D, the wall thickness T is about 3.489 millimeters, the distance between points A and B is about 4.492 millimeters, and the distance between points C and D is about 6.978 millimeters. The wall thickness T may be based upon an intended carrier frequency of radar wave transmission by the radar sensor 124.

The wall 390 of the radar cover 330 functions as a lens through which radar waves are transmitted. Accordingly, the wall 390 needs to have a uniform (i.e., constant) thickness within the area used for transmission, including the area at extreme edges of a radar cone wave pattern, such as represented by the arrow line 386 in FIG. 3D.

A number of advantages result by providing the radar cover 330 disclosed herein. One advantage is the radar cover 330 is secured to only the radar sensor assembly 120. Only brackets (e.g., the bracket 110 shown in FIG. 1) need to be changed to accommodate installation of the radar sensor assembly 120, and therefore also the radar cover 130, on different types and models of vehicles. Since only brackets need to be changed and the same radar cover 330 is used on different installations, the result is lower material costs resulting in lower total production costs. Since the radar cover 330 is independent of the radar mounting bracket 110, specialized provision for varied brackets need not be considered by the radar cover manufacturer. Only the bracket 110 needs to be adaptable to a wide variety of vehicle bumper configurations.

Another advantage is that the substantially uniform wall thickness of the wall 390 of the radar cover 330 supports optimized transmissivity of radar waves away from and reflected radar waves towards the radar sensor 124, as described hereinabove with reference to FIG. 3D.

Still another advantage is that the radar cover 330 is easy to install onto the radar sensor assembly 120. The inherent spring forces within the plurality of retention tabs 332, 334, 342, 344 allow the radar cover 330 to be easily clipped into place on the radar sensor assembly 120. Thus, the radar cover 330 is not only cost effective, but is also easy to install in retrofit applications as well as new production applications.

The advantages of having a substantially uniform wall thickness described hereinabove with reference to the schematic diagram of FIG. 3D are also applicable to the radar cover 130 of FIGS. 2 and 2A.

Although the above description describes a radar cover being used in a heavy vehicle such as a truck, it is conceivable that the radar cover may be used in other types of commercial vehicles, such as busses for example.

While the present disclosure has been illustrated by the description of example processes and system components, and while the various processes and components have been described in detail, applicant does not intend to restrict or in any way limit the scope of the appended claims to such detail. Additional modifications will also readily appear to those skilled in the art. The disclosure in its broadest aspects is therefore not limited to the specific details, implementations, or illustrative examples shown and described. Accordingly, departures may be made from such details without departing from the spirit or scope of applicant's general concept.

What is claimed is:

1. A vehicle radar apparatus comprising:
a radar cover including a wall having a longitudinal wall portion and at least one lateral wall portion curving away from the longitudinal wall portion and positioned relative to the longitudinal wall portion such that both wall portions have substantially uniform wall thickness.

2. A vehicle radar apparatus according to claim 1, wherein the at least one lateral wall portion includes (i) a first lateral wall portion curving away from a first end of the longitudinal wall portion, and (ii) a second lateral wall portion curving away from a second end of the longitudinal wall portion.

3. A vehicle radar apparatus according to claim 1, wherein the radar cover includes a plurality of retention tabs for enabling the radar cover to be secured to a radar sensor assembly without use of fasteners.

4. A vehicle radar apparatus according to claim 3, wherein each of the plurality of retention tabs clamps onto the radar sensor assembly to secure the radar cover to the radar sensor assembly.

5. A vehicle radar apparatus according to claim 3, wherein each of the plurality of retention tabs hooks onto the radar sensor assembly to secure the radar cover to the radar sensor assembly.

6. A vehicle radar apparatus according to claim 5, wherein each of the plurality of retention tabs hooks onto an edge of a back surface of a radar sensor of the radar sensor assembly to secure the radar cover to the radar sensor assembly.

7. A vehicle radar apparatus according to claim 3, wherein the radar cover has a plurality of slots that assist in creating a spring feature for the plurality of retention tabs to enable the radar cover to deflect during installation without permanently distorting shape of the radar cover.

8. A vehicle radar apparatus according to claim 1, wherein the radar cover includes a spoiler extending from edge of the radar cover and for deflecting and diverting airflow around the radar cover and away from back side of the radar cover.

9. A vehicle radar apparatus according to claim 1, wherein the radar cover includes at least two longitudinal locating features that assist in aligning a radar sensor assembly within the radar cover during installation.

10. A vehicle radar apparatus according to claim 1, wherein the radar cover has a plurality of drainage holes located at bottom of the radar cover to allow water and debris to drain.

11. A vehicle radar apparatus according to claim 1, wherein the thickness of the wall is based upon type of radar sensor.

12. A vehicle radar apparatus comprising:
a bracket fastenable to a vehicle part;
a radar sensor assembly fastened to the bracket and including a radar sensor for emitting radar waves and receiving reflected radar waves; and
a radar cover secured to the radar sensor assembly and for protecting the radar sensor from road debris during vehicle operation, wherein the radar cover has a wall thickness that is substantially uniform across a field of view of the radar sensor.

13. A vehicle radar apparatus according to claim 12, wherein the wall has a longitudinal wall portion and at least one lateral wall portion curving away from the longitudinal wall portion and positioned relative to the longitudinal wall portion such that both wall portions have substantially uniform wall thickness.

14. A vehicle radar apparatus according to claim 12, wherein the wall thickness of the radar cover is based upon type of the radar sensor.

15. A vehicle radar apparatus according to claim 12, wherein the wall thickness of the radar cover is based upon an intended carrier frequency of radar wave emission by the radar sensor.

16. A vehicle radar apparatus according to claim 12, wherein the radar cover includes a plurality of retention tabs for enabling the radar cover to be secured to only the radar sensor assembly and not the bracket.

17. A vehicle radar apparatus comprising:
a radar sensor assembly including a radar sensor for emitting radar waves and receiving reflected radar waves; and
a radar cover secured to the radar sensor assembly and for protecting the radar sensor from road debris during vehicle operation, wherein the radar cover includes a plurality of retention tabs for enabling the radar cover to be secured to the radar sensor assembly without use of fasteners.

18. A vehicle radar apparatus according to claim 17, wherein each of the plurality of retention tabs clamps onto the radar sensor assembly to secure the radar cover to the radar sensor assembly.

19. A vehicle radar apparatus according to claim 18, wherein each of the plurality of retention tabs has a slotted surface into which an edge surface of the radar sensor assembly can engage to clamp the radar cover onto the radar sensor assembly.

20. A vehicle radar apparatus according to claim 17, wherein each of the plurality of retention tabs hooks onto the radar sensor assembly to secure the radar cover to the radar sensor assembly.

21. A vehicle radar apparatus according to claim 20, wherein each of the plurality of retention tabs hooks onto an edge of a back surface of the radar sensor of the radar sensor assembly to secure the radar cover to the radar sensor assembly.

22. A vehicle radar apparatus according to claim 20, wherein each of the plurality of retention tabs has an extended surface onto which an edge surface of the radar sensor assembly can engage to hook the radar cover onto the radar sensor assembly.

23. A vehicle radar apparatus according to claim 17, wherein at least one of the plurality of retention tabs has an elongated slot through which a screwdriver can be inserted and used as a lever to remove the radar cover from the radar sensor assembly.

24. A vehicle radar apparatus according to claim 17, wherein the radar cover has a plurality of slots that assist in creating a spring feature for the plurality of retention tabs to enable the radar cover to deflect during installation without permanently distorting shape of the radar cover.

25. A vehicle radar apparatus according to claim 17, wherein the radar cover includes a spoiler extending from edge of the radar cover and for deflecting and diverting airflow around the radar cover and away from back side of the radar cover.

26. A vehicle radar apparatus according to claim 17, wherein the radar cover includes at least two longitudinal locating features that assist in aligning the radar sensor assembly within the radar cover during installation.

27. A vehicle radar apparatus according to claim 17, wherein the radar cover has a plurality of drainage holes located at bottom of the radar cover to allow water and debris to drain.
